(19) United States
(12) Patent Application Publication
(10) Pub. No.: US 2021/0223610 A1
(43) Pub. Date: Jul. 22, 2021

(54) LIQUID CRYSTAL DISPLAY DEVICE

(71) Applicant: Shenzhen China Star Optoelectronics Semiconductor Display Technology Co., Ltd., Shenzhen, Guangdong (CN)

(72) Inventor: Lixuan CHEN, Shenzhen, Guangdong (CN)

(21) Appl. No.: 16/301,831

(22) PCT Filed: Sep. 14, 2018
(86) PCT No.: PCT/CN2018/105645

§ 371 Date: Nov. 15, 2018

(30) Foreign Application Priority Data
Aug. 30, 2018 (CN) 201811005877.4

(51) Int. Cl. G02F 1/1335

(52) U.S. Cl. CPC G02F 1/133512

(57) ABSTRACT

A liquid crystal display device includes a first substrate, a second substrate, a liquid crystal layer, and a plurality of black matrix layers. The second substrate faces the first substrate and includes a plurality of grooves facing the first substrate. The liquid crystal layer is disposed between the first substrate and the second substrate. Each of the black matrix layers is disposed in a corresponding groove of the second substrate, to increase contrast and transmittance of the liquid crystal display device.

### FIELD OF INVENTION

The present disclosure relates to the field of display technologies, and more particularly to a liquid crystal display device.

### BACKGROUND OF INVENTION

In current technology and with reference to FIG. 1, a black matrix layer 140 of a conventional liquid crystal display device 10 is disposed on an upper substrate 120, thereby causing unevenness of an interface between the upper substrate 120 and a liquid crystal layer 130, and causing the liquid crystal layer 130 to be arranged along a topography of the uneven interface. Therefore, this causes abnormal orientation of the liquid crystal layer, which affects dark light leakage and transmittance of the liquid crystal display device 10.

Therefore, there is a need to provide a liquid crystal display device to solve the above technical problems in the current technology.

### SUMMARY OF INVENTION

In order to solve the above technical problems, an object of the present disclosure is to provide a liquid crystal display device capable of increasing contrast and transmittance of the liquid crystal display device by providing each black matrix layer in a corresponding groove of a second substrate.

To achieve the above object, an embodiment of the present disclosure provides a liquid crystal display device. The liquid crystal display device includes a first substrate, a second substrate, a liquid crystal layer, and a plurality of black matrix layers. The second substrate faces the first substrate and includes a plurality of grooves facing the first substrate. The liquid crystal layer is disposed between the first substrate and the second substrate. Each of the black matrix layers is disposed in a corresponding groove of the second substrate. A surface of the black matrix layer and a surface of the second substrate are in a same plane and constitute a flat surface. A height of the groove is equal to a height of the black matrix layer.

In an embodiment of the present disclosure, the height of the groove ranges between 0.5 um and 3 um.

In an embodiment of the present disclosure, the height of the black matrix layer ranges between 0.5 um and 3 um.

In an embodiment of the present disclosure, an extended length of the groove is equal to an extended length of the black matrix layer.

In an embodiment of the present disclosure, the grooves are strip-shaped and spaced apart from each other.

In an embodiment of the present disclosure, the black matrix layers are strip-shaped and spaced apart from each other.

In an embodiment of the present disclosure, the first substrate is a thin film transistor array substrate, and the second substrate is a color filter substrate.

An embodiment of the present disclosure further provides a liquid crystal display device. The liquid crystal display device includes a first substrate, a second substrate, a liquid crystal layer, and a plurality of black matrix layers. The second substrate faces the first substrate and includes a plurality of grooves facing the first substrate. The liquid crystal layer is disposed between the first substrate and the second substrate. Each of the black matrix layers is disposed in a corresponding groove of the second substrate.

In an embodiment of the present disclosure, a surface of the black matrix layer and a surface of the second substrate are in a same plane.

In an embodiment of the present disclosure, a surface of the black matrix layer and a surface of the second substrate constitute a flat surface.

In an embodiment of the present disclosure, a height of the groove ranges between 0.5 um and 3 um.

In an embodiment of the present disclosure, a height of the black matrix layer ranges between 0.5 um and 3 um.

In an embodiment of the present disclosure, a height of the groove is equal to a height of the black matrix layer.

In an embodiment of the present disclosure, an extended length of the groove is equal to an extended length of the black matrix layer.

In an embodiment of the present disclosure, the grooves are strip-shaped and spaced apart from each other.

In an embodiment of the present disclosure, the black matrix layers are strip-shaped and spaced apart from each other.

In an embodiment of the present disclosure, the first substrate is a thin film transistor array substrate, and the second substrate is a color filter substrate.

Because the liquid crystal display device in the embodiment of the present disclosure includes each of the black matrix layers disposed in the corresponding groove of the second substrate, this increases contrast and transmittance of the liquid crystal display device.

In order to make the above-mentioned contents of the present disclosure more comprehensible, preferred embodiments accompanied with drawings are described in detail as follows.

### DESCRIPTION OF DRAWINGS

FIG. 1 is a schematic structural view of a liquid crystal display device according to current technology.

FIG. 2 is a schematic structural view of a liquid crystal display device according to an embodiment of the present disclosure.

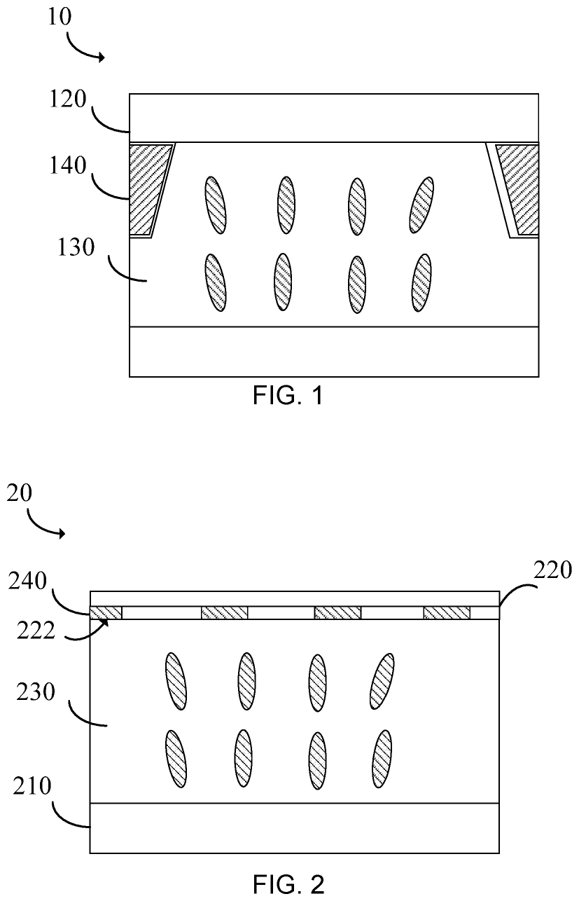

### DETAILED DESCRIPTION OF PREFERRED EMBODIMENTS

The embodiments described herein with reference to the accompanying drawings are explanatory, illustrative, and used to generally understand the present disclosure. Furthermore, directional terms described by the present disclosure, such as up, down, top, bottom, front, back, left, right, inner, outer, side, surrounding, center, horizontal, lateral, vertical, longitudinal, axial, radial, top layer, bottom layer, etc., are only directions by referring to the accompanying drawings, and thus the used terms are used only for the purpose of describing embodiments of the present disclosure and are not intended to be limiting of the present disclosure.

In the drawings, modules with similar structures are labeled with the same reference number.

Referring to FIG. 2, a schematic structural view of a liquid crystal display device according to an embodiment of the present disclosure is provided.

Referring to FIG. 2, the embodiment of the present disclosure provides a liquid crystal display device 20. The liquid crystal display device 20 includes a first substrate 210, a second substrate 220, a liquid crystal layer 230, and a plurality of black matrix layers 240. The second substrate 220 faces the first substrate 210. The second substrate 220 has a plurality of grooves 222. The grooves 222 face the first substrate 210. The liquid crystal layer 230 is disposed between the first substrate 210 and the second substrate 220. Each of the black matrix layers 240 is disposed in a corresponding groove 222 of the second substrate 220. The embodiment of the present disclosure can increase contrast and transmittance of the liquid crystal display device 20 by providing each of the black matrix layers 240 in the corresponding groove 222 of the second substrate 220.

In details, the black matrix layer 240 is coated on the second substrate 220 having a plurality of steps (that is the grooves 222) and the black matrix layer 240 is patterned using exposure and development. The grooves 222 on the second substrate 220 are same as patterns formed by the black matrix layers 240, such as a straight line and a straight row. By improving flatness of the second substrate 220, it facilitates formation of a photoresist and indium tin oxide (ITO). The second substrate 220 of the embodiment of the present disclosure is not limited in its material. The grooves 222 are not limited to its manufacture, and can be formed using a mechanical means, a laser wire scanning, or embossing.

In details, a surface of the black matrix layer 240 and a surface of the second substrate 220 are in a same plane. The surface of the black matrix layer 240 and the surface of the second substrate 220 constitute a flat surface. A height of the groove 222 ranges between 0.5 um and 3 um. A height of the black matrix layer 240 ranges between 0.5 um and 3 um. The height of the groove 222 is approximately equal to the height of the black matrix layer 240. An extended length of the groove 222 is approximately equal to an extended length of the black matrix layer 240. The grooves 222 are strip-shaped and spaced apart from each other. The black matrix layers 240 are strip-shaped and spaced apart from each other. The first substrate 210 is, for example, a thin film transistor array substrate, and the second substrate 220 is, for example, a color filter substrate.

Because the liquid crystal display device in the embodiment of the present disclosure includes each of the black matrix layers disposed in the corresponding groove of the second substrate, this increases contrast and transmittance of the liquid crystal display device.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

The above descriptions are merely preferred implementations of the present disclosure, it should be noted that those of ordinary skill in the art can make a variety of improvements and substitutions on the premise of not deviating from the technical principle of the present disclosure, and these improvements and substitutions should be encompassed within the protection scope of the present disclosure.

1. A liquid crystal display device, comprising:
a first substrate;
a second substrate facing the first substrate, the second substrate comprising a plurality of grooves facing the first substrate;
a liquid crystal layer disposed between the first substrate and the second substrate; and
a plurality of black matrix layers, each of the black matrix layers disposed in a corresponding groove of the second substrate;
wherein a surface of the black matrix layer and a surface of the second substrate are in a same plane and constitute a flat surface;
wherein a height of the groove is equal to a height of the black matrix layer.

2. The liquid crystal display device according to claim 1, wherein the height of the groove ranges between 0.5 um and 3 um.

3. The liquid crystal display device according to claim 1, wherein the height of the black matrix layer ranges between 0.5 um and 3 um.

4. The liquid crystal display device according to claim 1, wherein an extended length of the groove is equal to an extended length of the black matrix layer.

5. The liquid crystal display device according to claim 1, wherein the grooves are strip-shaped and spaced apart from each other.

6. The liquid crystal display device according to claim 1, wherein the black matrix layers are strip-shaped and spaced apart from each other.

7. The liquid crystal display device according to claim 1, wherein the first substrate is a thin film transistor array substrate and the second substrate is a color filter substrate.

8. A liquid crystal display device, comprising:
a first substrate;
a second substrate facing the first substrate, the second substrate comprising a plurality of grooves facing the first substrate;
a liquid crystal layer disposed between the first substrate and the second substrate; and
a plurality of black matrix layers, each of the black matrix layers disposed in a corresponding groove of the second substrate.

9. The liquid crystal display device according to claim 8, wherein a surface of the black matrix layer and a surface of the second substrate are in a same plane.

10. The liquid crystal display device according to claim 8, wherein a surface of the black matrix layer and a surface of the second substrate constitute a flat surface.

11. The liquid crystal display device according to claim 8, wherein a height of the groove ranges between 0.5 um and 3 um.

12. The liquid crystal display device according to claim 8, wherein a height of the black matrix layer ranges between 0.5 um and 3 um.

13. The liquid crystal display device according to claim 8, wherein a height of the groove is equal to a height of the black matrix layer.

14. The liquid crystal display device according to claim 8, wherein an extended length of the groove is equal to an extended length of the black matrix layer.

15. The liquid crystal display device according to claim 8, wherein the grooves are strip-shaped and spaced apart from each other.

16. The liquid crystal display device according to claim 8, wherein the black matrix layers are strip-shaped and spaced apart from each other.

17. The liquid crystal display device according to claim 8, wherein the first substrate is a thin film transistor array substrate and the second substrate is a color filter substrate.
